(19) United States
(12) Patent Application Publication
(10) Pub. No.: US 2003/0125993 A1
(43) Pub. Date: Jul. 3, 2003

(54) Method and system for event distribution

(76) Inventors: Chi Fai Ho, Sunnyvale, CA (US); Madhu Grandhi, Fremont, CA (US)

Correspondence Address: Mathews, Collins, Shepherd & Gould, P.A., 100 Thanet Circle, Suite 306, Princeton, NJ, 08540, US

(21) Appl. No.: 10/032,834

(22) Filed: Dec. 27, 2001

(51) Int. Cl. G06F 17/60

(52) U.S. Cl. 705/5

(57) ABSTRACT

The present invention relates to a method and system for distributing events in a data processing system using a scaleable hierarchical architecture. Recipient processes desirous of receiving events are registered with a distribution process. Thereafter, when an event is received at the distribution process, it is determined if one or more recipients are registered to receive the event. The event is forwarded to one or more recipients determined to be registered to receive the event. If no recipients are registered to receive the event, the event is dropped. A linked list tree can be used to register the events. A linked list tree can be used to register recipients. The linked list tree provides scalability. The invention allows known and future processes, such as processes of new software versions, to receive events by registering with the distribution process.

### BACKGROUND OF THE INVENTION

1. Field of the Invention

The present invention relates in general to a method and system for data processing and in particular to a method and system for distributing events in a data processing system.

2. Description of Related Art

Software applications have traditionally included processes which receive and generate events between processes. Events can relate to an action to be performed. For example, an event can be an alarm which when received, invokes a predetermined action.

U.S. Pat. No. 5,751,914 describes a system for correlating a plurality of Single Network Management Protocol (SNMP) events within a data processing system by evaluating the events with respect to a predetermined rule in order to determine an action to be performed. A rule network is provided which includes a number of objects arranged in a tree structure having a least one parent object logically linked to a plurality of child objects by passing an input event received by the parent object to the child object. At least one of the objects within the rule network invokes an action in response to receipt of a particular input event. In response to receipt of a series of events, the series of events is evaluated through the tree structure rule network. In response to the evaluation, an action is invoked at one of the number of objects. This patent has the limitation of coordinating a rule to be used with multiple events of a known software application.

Often new processes will need to respond to events that have been generated by predecessor processes. The predecessor processes never have reliable knowledge of future processes. Therefore a mechanism is needed to generate events and receive events without new processes impacting the operation or design of predecessor processes.

### SUMMARY OF THE INVENTION

The present invention relates to a method and system for distributing events in a data processing system using a scaleable hierarchical architecture. Recipient processes desirous of receiving events are registered with a distribution process. Thereafter, when an event is received at the distribution process, it is determined if one or more recipients are registered to receive the event. The event is forwarded to one or more recipients determined to be registered to receive the event. If no recipients are registered to receive the event, the event is dropped.

A linked list tree can be used to register the events. An event linked list logically links the event entries. One or more process linked lists branch off the event linked list. The one or more process linked lists logically link recipient processes desirous of receiving the associated event. The linked list tree can be dynamically updated to add new event entries or new recipient process entries. The linked list tree provides scalability. The invention allows known and future processes, such as processes of new software versions, to receive events by registering with the distribution process.

The invention will be more fully described by reference to the following drawings.

### BRIEF DESCRIPTION OF THE DRAWINGS

FIG. 1 is a schematic diagram of a system for event distribution in accordance with the teachings of the present invention.

FIG. 2 is a flow diagram of an implementation of a distribution process.

FIG. 3 is a schematic diagram of an implementation of a linked list tree for registering events for the distribution process including logical links between event codes and logical links between recipients.

FIG. 4 is a schematic diagram of an architecture for an implementation of a linked list tree.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

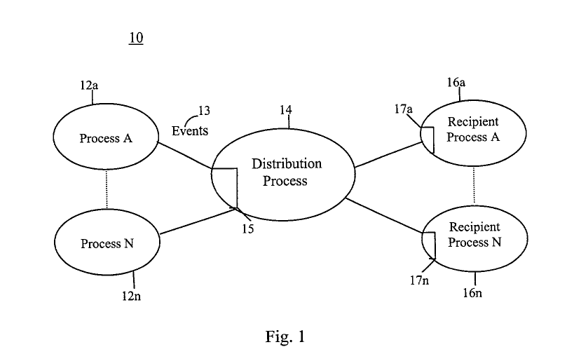

FIG. 1 is a schematic diagram of a system for event distribution 10 according to the present invention. Processes 12a-12n generate events 13. Events 13 comprise information such as event states, event conditions, and alarms. Events 13 can include a predetermined fixed amount of information. Distribution process 14 receives events 13 from processes 12a-12n in event queue 15. Distribution process 14 determines distribution of events 13 to recipient queues 17a-17n associated with respective recipient processes 16a-16n.

Processes 12a-12n, distribution process 14, and recipient processes 16a-16n can be implemented on an individual computer. As is common, the computer includes at least an operating system, memory, input/output device may be coupled to a storage device and printer. Additional devices as appreciated by those skilled in the art as are used in a data processing system can be included. Alternatively, processes 12a-12n, distribution process 14, recipient processes 16a-16n can be implemented on one or more computers coupled to one or more networks using respective communications links and communications controller. As will be understood by those skilled in the art a data processing can include gateways, gateway servers, routers, bridges, protocols and various other network hardware and software utilized to interconnect segments of the data processing system.

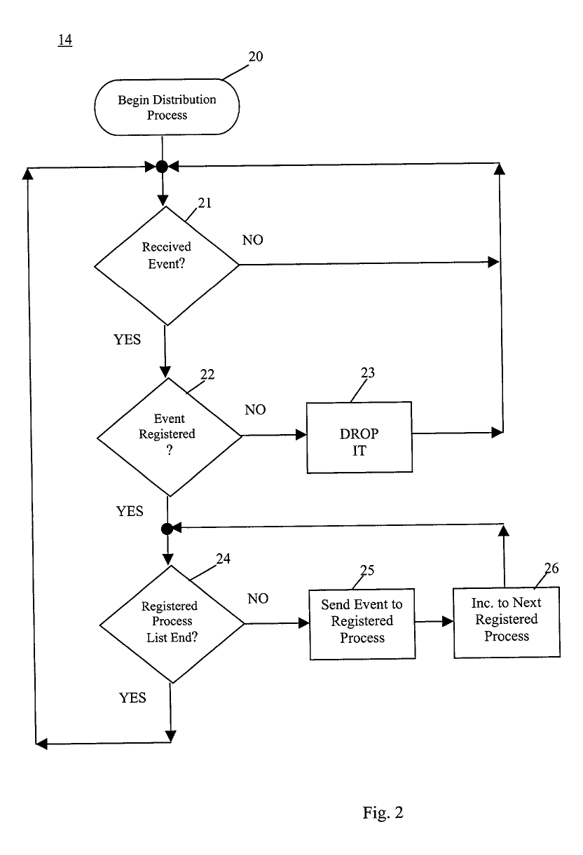

FIG. 2 is a flow diagram of an implementation of distribution process 14. In entry block 20, distribution process 14 is initiated. During initiation, each of recipient processes 16a-16n register with distribution process 14 which events are desired to be received from distribution process 14. The events can be registered by establishing a linked list tree of logical links between events and logical links between recipient processes desirous of receiving the same event, as described in detail below. Alternatively, the events can be registered by establishing a two-dimensional table of events and recipient processes desirous of receiving one or more of the events. In decision block 21, it is determined if an event has been received by distribution process 14. If an event has not been received in decision block 21, distribution process 14 returns to decision block 21 to determine if a subsequent event has been received. If an event has been received, it is determined if the event is registered with distribution process 14, in decision block 22. If the event has not been registered, the event is dropped in drop block 23 and no further processing of the event occurs and distribution process 14 returns to decision block 21. If the event has been registered, decision block 24 is performed.

In decision block 24, it is determined if the list of logical links between the registered recipient processes is at an end. If the list of logical links to registered recipient processes is not at an end, the event is sent to the registered recipient process associated with the current pointer for the list of logical links to registered recipient processes, in send block 25. In increment block 26, the list of logical links to registered recipient processes is updated to point to the next registered recipient process in the list of logical links of registered recipient processes. After the current pointer for the list of logical links is updated, distribution process 14 returns to decision block 24. If the list of logical links of events is at an end in decision block 24, distribution process 14 returns to decision block 21.

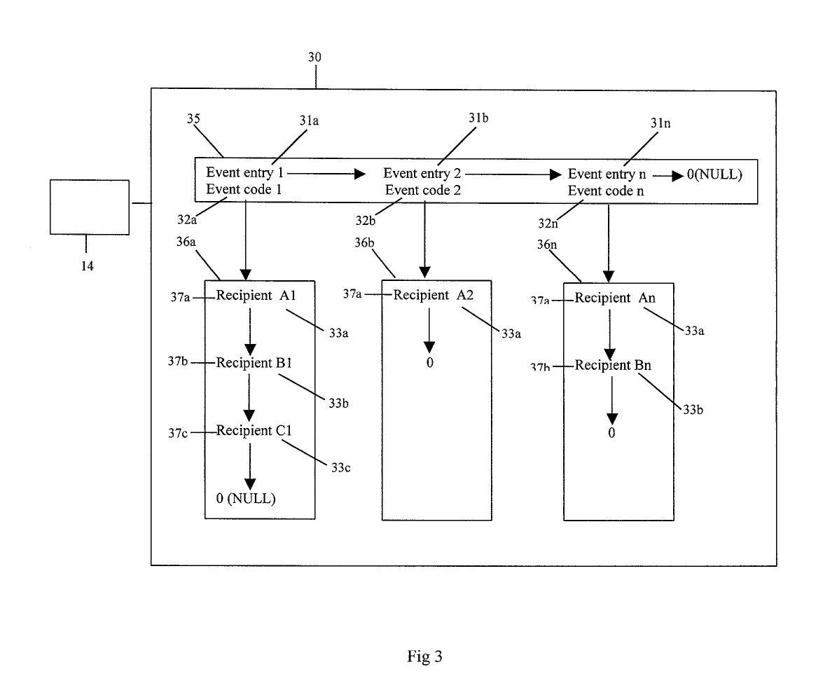

Registration of recipient processes 16a-16n with distribution process 14 can be performed using a linked list tree. An example of a linked list tree of logical links for events and logical links for registered recipient processes is shown in FIG. 3. Linked list tree 30 comprises a plurality of linked lists of distribution process components. Linked list tree 30 is coupled to distribution process 14 or integral with distribution process 14. For example, distribution process components can comprise event code 32 and recipient process identification 33. Event code 32 is an identification assigned to each type of event 13. Recipient process identification 33 is an identification assigned to each of recipient processes 16a-16n. Event linked list 35 links a plurality of event entries 31a-31 n. Each of event entries 31a-31n include a respective event code 32a-32n. A null (0) element at the end of event linked list 35 indicates the end of event linked list 35 and that there are no additional event entries 31 to be parsed.

Process linked lists 36a-36n link recipient process entries 37a-37n of one or more recipient processes 16a-16n. Each of recipient process entries 37a-37n include a respective recipient process identification 33. A null (0) element at the end of each of process linked lists 36a-36n indicates the end of the respective process linked list 36a-36n and that there are no more recipient process entries 37a-37n to be parsed.

In the example linked list tree 30 shown in FIG. 3, process linked list 36a comprises recipient process entries 37a, 37b and 37c. Process linked list 36b comprises recipient process entry 37a. Process linked list 36n comprises recipient process entries 37a and 37b. It will be appreciated that linked list tree 30 can have numerous variations depending on determined registration of events 13 and recipients processes 16a-16n.

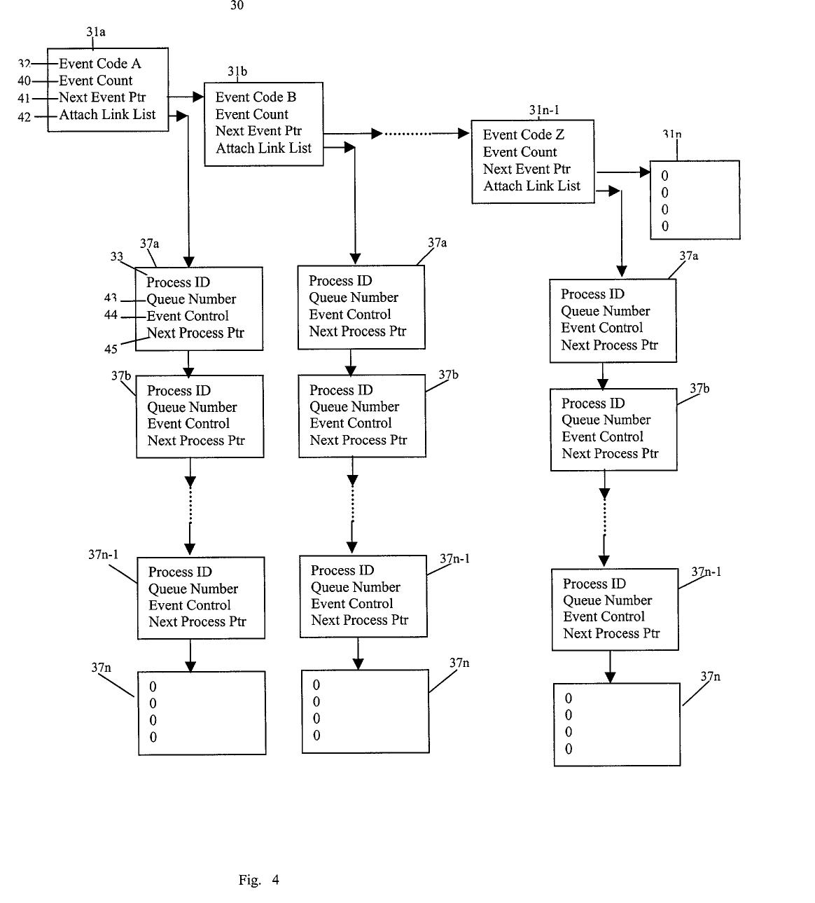

FIG. 4 is a schematic diagram of an implementation of a detailed architecture of linked list tree 30. Event entries 31a-31n comprises event code 32, event count 40, next event pointer 41 and attach process link list pointer 42.

Event count 40 indicates the amount of times each event 13 issues from processes 12a-12n. Event count 13 can be used as a statistic for monitoring processes 12a-12n. Distribution process 14 can monitor event count 40 to determine if an emergency condition exists. For example, if event count 40 is updated over a threshold amount in a predetermined time interval, it could indicate process 12a-12n was rapidly switching states. Rapid switching of states could indicate a possible emergency such as a temperature sensor of a PC board causing fans to rapidly go on and off and rapidly sending events.

Next event pointer 41 points to the respective next event entry 31b-31n of event linked list 35. Attach process link list pointer 42 points to a respective one of process linked lists 36a-36n. Event entry 31n comprises a 0 zero end flag for next event pointer 41 indicating the end of event linked list 35 and a 0 zero end flag for attach process link pointer 42 indicating no process linked lists 36 are attached to event entry 31n.

Recipient process entries 37a-37n comprise a respective recipient process identification 33, recipient process queue number 43, event control 44 and next process pointer 45. Recipient process queue number 43 identifies an address of a respective queue 17 of recipient processes 16a-16n for receiving a distributed event. Event control 44 includes information directed to an action to be taken upon receipt of event 13. Next process pointer 45 points to the next recipient process entry 37b-37n. Recipient process entry 37n comprises a 0 zero end flag for next process pointer 45 indicating the end of the respective process linked list 36a-36n.

Events 13 which were received in event message queue 15 of distribution process 14, are matched to event code 32 by determining event code 32 for event 13 received in message queue 15 and comparing the determined event code 32 with one or more event codes 32 stored in event linked list 35. Upon a match of event code 32 of received event 13 with event code 32 stored in event linked list 35, respective one or more recipient process identifications 33 in association with one of process linked lists 36a-36n are located for the matched event code 32. If one or more recipient process identifications 33 are identified, event 13 is copied from event message queue 15 to each corresponding recipient message queue 17a-17n identified by a respective recipient process queue number 43.

Linked list tree 30 can be dynamically updated to add new recipient process entries 37 as recipient processes 16a-16n are updated or new recipient processes 16 are invoked. New event code entries 31 can be added at any location in event linked list 35 by appropriately updating next event pointer 41 before the added entry. New recipient process entries 37 can be added at any location in process linked list 36 by appropriately updated next process pointer 45 before the added entry.

Recipient processes 16a-16n can discontinue receiving previously registered events without removal of the registered recipient process entry 37 from linked list tree 30 by setting event control 44. Event control 44 can include an identified number of bits with each bit or combination representing features of distribution process 14. For example, event control 44 can include 16 bits with a least significant bit being used to enable or disable sending event 13 to a determined registered recipient process 16a-16n. In one implementation if the least significant bit is a “1,” a received event 13 is sent to the determined registered recipient processes 16a-16n and if the least significant bit is a “0,” event 13 is not sent.

It is to be understood that the above-described embodiments are illustrative of only a few of the many possible specific embodiments which can represent applications of the principles of the invention. Numerous and varied other arrangements can be readily devised in accordance with these principles by those skilled in the art without departing from the spirit and scope of the invention.

What is claimed is

1. A method for distributing events in a data processing system comprising the steps of:
registering one or more recipients desirous of receiving one or more events with a distribution process;
in response to receiving events at said distribution process, determining if said one or more recipients are registered to receive said event; and
in response to said determination, forwarding said received event from said distribution process to said one or more recipients if said one or more recipients are registered to receive said event or dropping said event if said one or more recipients are not registered to receive said event.

2. The method of claim 1 wherein said one or more recipients are registered by creating a linked list tree comprising an event linked list logically linking one or more event entries, each of said event entries associated with one of said events, and optionally one of one or more process linked lists logically linking respective recipient process entries, each of said recipient process entries associated with said one or more recipients desirous of receiving one or more events.

3. The method of claim 2 wherein each of said one or more process linked lists is associated with one of said event entries in said event linked list.

4. The method of claim 3 wherein said step of determining if said one or more recipients is registered to receive said event is performed by parsing said event linked list for matching said received one or more events to one of said event entries and parsing said process linked list associated with said matched event entry in said event linked list for determining recipient process entries associated with said matched event entry.

5. The method of claim 2 wherein said event entry comprises an event code identifying said event.

6. The method of claim 5 wherein said event code of said event entry is matched to an event code of said received one or more events.

7. The method of claim 2 wherein said event entry comprises an event count for indicating a number of times said event was received at said distribution process.

8. The method of claim 2 wherein said event entry comprises a next event pointer for pointing to a next said event entry in said event linked list.

9. The method of claim 2 wherein said event entry comprises an attach process link list pointer for pointing to one of said process linked lists.

10. The method of claim 2 wherein said recipient processes entry comprises a recipient process identification for providing indexed access.

11. The method of claim 2 wherein said recipient process entry comprises a recipient process queue number for identifying an address of a recipient process queue for receiving said forwarded event from said distribution process.

12. The method of claim 2 wherein said recipient process entry comprises an event control which includes information of an action to be taken upon receiving said forwarded event at said distribution process.

13. The method of claim 12 wherein said event control is set to indicate if said event is forwarded in said step of forwarding said received event from said distribution process to said one or more recipients.

14. The method of claim 2 wherein said recipient process entry comprises a next process pointer for pointing to a next said recipient process entry in said process linked list.

15. The method of claim 2 further comprising the step of updating said event linked list for adding a subsequent event entry.

16. The method of claim 2 further comprising the step of:
updating said process linked list for adding a subsequent recipient process entry.

17. A system for distributing events in a data processing system comprising:
means for registering one or more recipients desirous of receiving one or more events with a distribution process;
means for determining if said one or more recipients are registered to receive said event in response to receiving events at said distribution process; and
means for forwarding said received event from said distribution process to said one or more recipients if said one or more recipients are registered to receive said event or dropping said event, if said one or more recipients are not registered to receive said event.

18. The system of claim 17 wherein said one or more recipients are registered by creating a linked list tree comprising an event linked list logically linking one or more event entries, each of said event entries associated with one of said events and optionally one of one or more process linked lists logically linking respective recipient process entries, each of said recipient process entries associated with said one or more recipients desirous of receiving one or more events.

19. The system of claim 18 wherein each of said one or more process linked lists is associated with one of said event entries in said event linked list.

20. The system of claim 17 wherein said means for determining if said one or more recipients is registered to receive said event is performed by parsing said event linked list for matching said received one or more events to one of said event entries and parsing said process linked list associated with said matched event entry in said event linked list for determining recipient process entries associated with said matched event entry.

21. The system of claim 18 wherein said event entry comprises an event code identifying said event.

22. The system of claim 21 wherein said event code of said event entry is matched to an event code of said received one or more events.

23. The system of claim 18 wherein said event entry comprises an event count for indicating a number of times said event was issued.

24. The system of claim 18 wherein said event entry comprises a next event pointer for pointing to a next said event entry in said event linked list.

25. The system of claim 18 wherein said event entry comprises an attach process link list pointer for pointing to one of said process linked lists.

26. The system of claim 18 wherein said recipient processes entry comprises a recipient process identification for providing indexed access.

27. The system of claim 18 wherein said recipient process entry comprises a recipient process queue number for identifying an address of a recipient process queue for receiving said forwarded event from said distribution process.

28. The system of claim 18 wherein said recipient process entry comprises an event control which includes information of an action to be taken upon receiving said forwarded event from said distribution process.

29. The system of claim 18 wherein said event control is set to indicate if said event is forwarded in said step of forwarding said received event from said distribution process to said one or more recipients.

30. The system of claim 18 wherein said recipient process entry comprises a next process pointer for pointing to a next said recipient process entry in said process linked list.

31. The system of claim 18 further comprising:
means for updating said event linked list for adding a subsequent event entry.

32. The system of claim 18 further comprising:
means for updating said process linked list for adding a subsequent recipient process entry.

33. A method for distributing events in a data processing system comprising the steps of:
registering one or more recipient processes desirous of receiving one or more events with a distribution process by creating a linked list tree comprising an event linked list logically linking one or more event entries, each of said event entries associated with one of said events, and optionally one of one or more process linked lists logically linking respective recipient process entries, each of said process recipient process entries associated with said one or more recipients desirous of receiving one or more events, each of said one or more process linked lists is associated with one of said event entries in said event linked list;
receiving an event at said distribution process;
determining if said one or more recipient processes are registered to receive said event; and
forwarding said received event from said distribution process to said one or more recipient processes if said one or more recipient processes are registered to receive said event or dropping said event, if said one or more recipient processes are not registered to receive said event.

34. The method of claim 33 wherein said step of determining if said one or more recipients is registered to receive said event is performed by parsing said event linked list for matching said received event to one of said event entries and parsing said process linked list associated with said matched event entry in said event linked list for determining recipient process entries associated with said matched event entry.

35. The method of claim 33 further comprising the step of updating said event linked list for adding a subsequent event entry.

36. The method of claim 33 further comprising the step of:
updating said process linked list for adding a subsequent recipient process entry.

37. A system for distributing events in a data processing system comprising:
a linked list tree having an event linked list logically linking one or more event entries, each of said event entries associated with one of said events and optionally one of one or more process linked lists logically linking respective recipient process entries associated with one or more recipient processes, each of said one or more process linked lists is associated with one of said event entries in said event linked list;
means for receiving events at said distribution process;
means for parsing said linked list tree for determining if said one or more recipient processes are registered to receive a received said event; and
means for forwarding said received event to said one or more recipient processes if said one or more recipient processes are registered to receive said event or dropping said event, if said one or more recipient processes are not registered to receive said event.

38. The system of claim 37 wherein said means for determining if said one or more recipients is registered to receive said event is performed by parsing said event linked list for matching said received event to one of said event entries and parsing said process linked list associated with said matched event entry in said event linked list for determining recipient process entries associated with said matched event entry.

39. The system of claim 37 further comprising a subsequent event entry added to said event linked list.

40. The system of claim 37 further comprising:
a subsequent recipient process entry added to said process linked list.

41. A method for distributing events in a data processing system comprising the steps of:
registering one or more recipient processes desirous of receiving one or more events with a distribution process by creating a linked list tree comprising an event linked list logically linking one or more event entries, each of said event entries associated with one of said events, and optionally one of one or more process linked lists logically linking respective recipient process entries, each of said process recipient process entries associated with said one or more recipients desirous of receiving one or more events, each of said one or more process linked lists is associated with one of said event entries in said event linked list;
receiving an event at said distribution process;
determining if said one or more recipient processes are registered to receive said event;
forwarding said received event from said distribution process to said one or more recipient processes if said one or more recipient processes are registered to receive said event or dropping said event, if said one or more recipients are not registered to receive said event, if said one or more recipient processes are not registered to receive said event; and
updating said event linked list for adding a subsequent event entry.

42. A method for distributing events in a data processing system comprising the steps of:
registering one or more recipient processes desirous of receiving one or more events with a distribution process by creating a linked list tree comprising an event linked list logically linking one or more event entries, each of said event entries associated with one of said events, and optionally one of one or more process linked lists logically linking respective recipient process entries, each of said process recipient process entries associated with said one or more recipients desirous of receiving one or more events, each of said one or more process linked lists is associated with one of said event entries in said event linked list;
receiving an event at said distribution process;
determining if said one or more recipient processes are registered to receive said event;
setting an event control in said event entry indicating to send said event or to not send said event; and
forwarding said received event to said distribution process to said one or more recipient processes if said one or more recipient processes are registered to receive said event and said event control indicates to sent said event or dropping said event, if said one or more recipients are not registered to receive said event or said event control indicated not to send said event.

43. A system for distributing events in a data processing system comprising:
a linked list tree having an event linked list logically linking one or more event entries, each of said event entries associated with one of said events and optionally one of one or more process linked lists logically linking respective recipient process entries associated with one or more recipient processes, each of said one or more process linked lists is associated with one of said event entries in said event linked list;
means for receiving events at said distribution process;
means for determining if said one or more recipient processes are registered to receive a received said event;
means for setting an event control in said event entry indicating to send said event or to not send said event; and
means for forwarding said received event to said one or more recipient processes if said one or more recipient processes are registered to receive said event and said event control indicates to sent said event or dropping said event, if said one or more recipient processes are not registered to receive said event or said event control indicated not to send said event.

44. A computer program product within a computer readable medium for causing distribution of events in a data processing system comprising:
instruction means for causing a distribution process to register one or more recipients desirous of receiving one or more events;
instruction means for causing a determination if said one or more recipients are registered to receive said event in response to receiving events at said distribution process; and
instruction means for causing forwarding of said received event from said distribution process to said one or more recipients if said one or more recipients are registered to receive said event or dropping said event, if said one or more recipients are not registered to receive said event.

45. The computer program product of claim 44 wherein said one or more recipients are registered by instruction means for creating a linked list tree comprising an event linked list logically linking one or more event entries, each of said event entries associated with one of said events and optionally one of one or more process linked lists logically linking respective recipient process entries, each of said recipient process entries associated with said one or more recipients desirous of receiving one or more events.

46. The computer program product of claim 45 wherein each of said one or more process linked lists is associated with one of said event entries in said event linked list.

47. The computer program product of claim 45 wherein said instruction means for determination if said one or more recipients is registered to receive said event is performed by parsing said event linked list for matching said received one or more events to one of said event entries and parsing said process linked list associated with said matched event entry in said event linked list for determining recipient process entries associated with said matched event entry.

48. The computer program product of claim 46 further comprising:
instruction means for updating said event linked list for adding a subsequent event entry.

49. The computer program product of claim 46 further comprising:
instruction means for updating said process linked list for adding a subsequent recipient process entry.
